(19) United States
(12) Patent Application Publication
(10) Pub. No.: US 2002/0122655 A1
(43) Pub. Date: Sep. 5, 2002

(54) Component receptacle device with an optical sensor means

(75) Inventor: Martin Pruefer, Muenchen (DE)

Correspondence Address: BAKER BOTTS LLP, 44TH FLOOR, 30 ROCKEFELLER PLAZA, NEW YORK, NY, 10112-4498, US

(73) Assignee: Siemens Dematic AG

(21) Appl. No.: 09/886,483

(22) Filed: Jun. 21, 2001

(30) Foreign Application Priority Data
Jan. 9, 2000 (DE) 101 006 18.7

(51) Int. Cl. G02B 6/00; G02B 6/26

(52) U.S. Cl. 385/147; 385/12

(57) ABSTRACT

Component receptacle device (1) of an automatic placement machine for printed circuit boards (2), having at least one suction pipette (5) which serves for receiving a component (8) and interacts with an optical sensor means, wherein the optical sensor means is arranged laterally beside the suction pipette (5) in such a way that the actual position of the suction pipette (5) can be detected by way of the longitudinal profile parameters thereof, evaluation means connected downstream providing information about deviations with respect to a defined desired position of the suction pipette (5) as well as configuration information.

The present invention relates to a component receptacle device of an automatic placement machine for printed circuit boards, having at least one suction pipette which serves for receiving a component and interacts with an optical sensor means.

In a generally known manner, in an automatic placement machine of the type of interest here, an electronic component is transported by means of a component receptacle device which takes a component from a component storage unit to a printed circuit board to be populated by means of at least one suction pipette which can be moved by means of a center sleeve. The component receptacle device comprises, for example, a 6- or 12-segment turret head with horizontal axis of rotation which is fitted to a portal axle system with linear motors in order to perform printed circuit board population according to the Collect&Place principle. In addition, component receptacle devices are also known which operate sequentially according to the Pick&Place principle and are mainly used for the placement of relatively large components.

In the course of increasing miniaturization of the components, dimensional tolerances on elements of the component receptacle device come to the fore to a greater extent for the purpose of ensuring correct population of the printed circuit board. In particular when collecting a small component (e.g. GF 0201) from the component storage unit, the suction pipette must be positioned precisely relative to the small component.

As has been shown in practice, positional and dimensional accuracy deviations in the region of the suction pipette lead, with increasing miniaturization of the components, to a rising error rate during collection. Thus, deviations specifically occur in the axial symmetry between the suction pipette and the center sleeve, for example due to center sleeve flexure, a suction pipette that is not tightly fitted, or on account of production tolerances of the suction pipette or the like. For all these reasons, the axis of the suction pipette and the optical axis of rotation may diverge in such a way that, during the positioning of the suction pipette, it is no longer possible for a small component to be reliably received.

WO 99/49713 discloses a component receptacle device of the generic type. In this component receptacle device, with the aid of laterally arranged optical sensor means in interaction with a light source, however, it is only after the component has been collected that its presence can be determined on the suction pipette by way of length differences in order to be able to identify a component receiving process that has not taken place correctly. Therefore, the optical sensor means in this case appropriately has a linear sensor area.

WO 00/52987 discloses a component receptacle device with an optical sensor means which, designed as a camera, records a cross-sectional image of the pipette tip. To this purpose, the camera is arranged at the end face with respect to the suction pipette. A subsequent DESIRED-ACTUAL comparison of the cross-sectional parameters of the pipette tip enables the suction pipette to be assessed only with regard to identity, contamination and damage.

By contrast, the object of the present invention is to provide a component receptacle device which, using optical sensor means, does not solely take account of configuration information of the suction pipette but also, in addition, enables reliable positioning of the suction pipette when receiving components.

Proceeding from a device in accordance with the preamble of claim 1, the object is achieved in conjunction with the characterizing features of claim 1. The subsequent dependent claims represent advantageous developments of the invention.

The invention includes the technical teaching that an optical sensor means is arranged laterally beside the suction pipette in such a way that the actual position of the suction pipette can be detected by way of the longitudinal profile parameters thereof, evaluation means connected downstream providing information about deviations with respect to a defined desired position of the suction pipette as well as configuration information.

Preferably, the optical sensor means is in this case designed in the manner of a camera. For this purpose, given appropriate modification of the sensor area, it is also possible to use an existing camera which is already used for measuring the components in the prior art.

Suction pipettes known heretofore are usually made matt black since, during image recording, they should not produce any structures that can be evaluated by image processing. These kinds of suction pipettes are not very suitable, therefore, for optical measurements. In order to detect the actual position and also the configuration of the suction pipette, the suction pipette can be internally illuminated. By virtue of this measure, the position of the suction pipette can be detected exactly by the camera since a high-contrast image having few gray gradations is produced which can be optimally evaluated by the image processing connected downstream. It is also possible to measure the pipette center and the exact position of the pipette tip and to perform accurate positioning in a manner dependent thereon. In addition, from the size of the outlet opening of the air duct, contamination by solder paste or the like can be inferred. Furthermore, the degree of pipette wear and deformations of the pipette tip and other configuration information appertaining to the suction pipette can also be determined and evaluated.

Preferably, the internal illumination of the suction pipette can be effected by light being scattered in at the end, the longitudinally running air duct, as optical detection line, standing out as bright relative to the surroundings. In this case, the light source may advantageously be arranged in the suction pipette itself or in the center sleeve.

It is also conceivable to arrange the light source for internal illumination outside suction pipette or center sleeve, and to provide means for forwarding the light from the light source to the suction pipette or center sleeve. Optical fibers can advantageously be used for this purpose. Thus, for connection of the optical fibers, the center sleeve may be equipped, in its rear region remote from the suction pipette, with a hole which runs coaxially with respect to the longitudinally running air duct and into which the optical fibers are inserted in a sealed manner.

The light source can be installed either on the movable side or on the stationary side of the component receptacle device. In the latter case, an optical coupling to the light source can be produced at the boundary point toward the movable side.

Further measures which improve the invention are presented in greater detail below together with the description of preferred exemplary embodiments of the invention with reference to the figures, in which:

FIG. 1 shows a side view of a component receptacle device of an automatic placement machine,

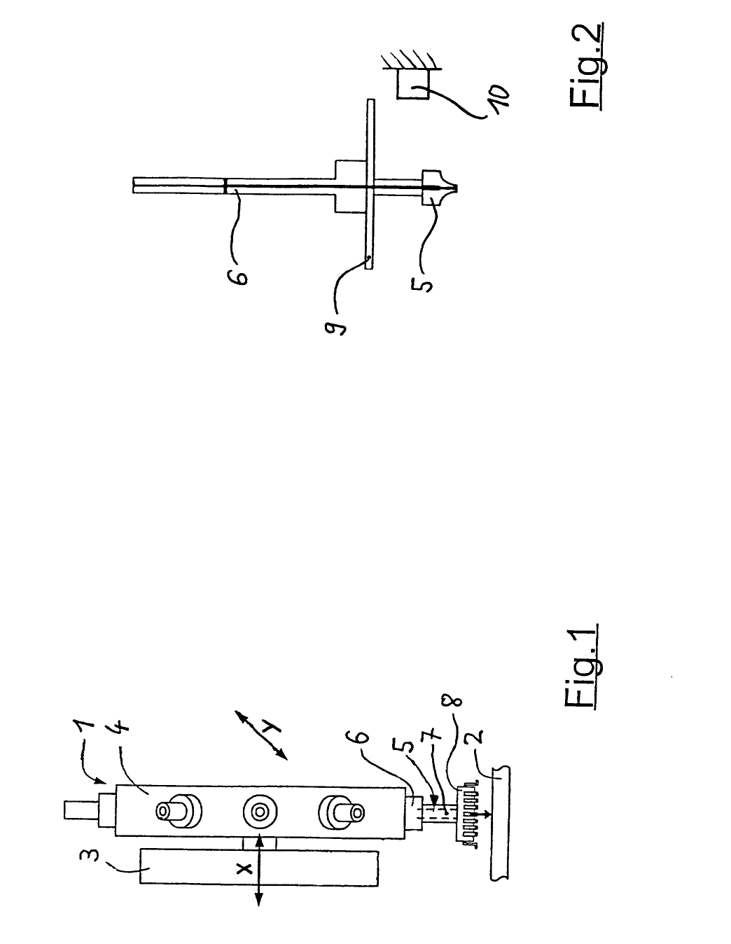

FIG. 2 shows a side view of a suction pipette arranged on an individual center sleeve, with an optical sensor means according to the invention,

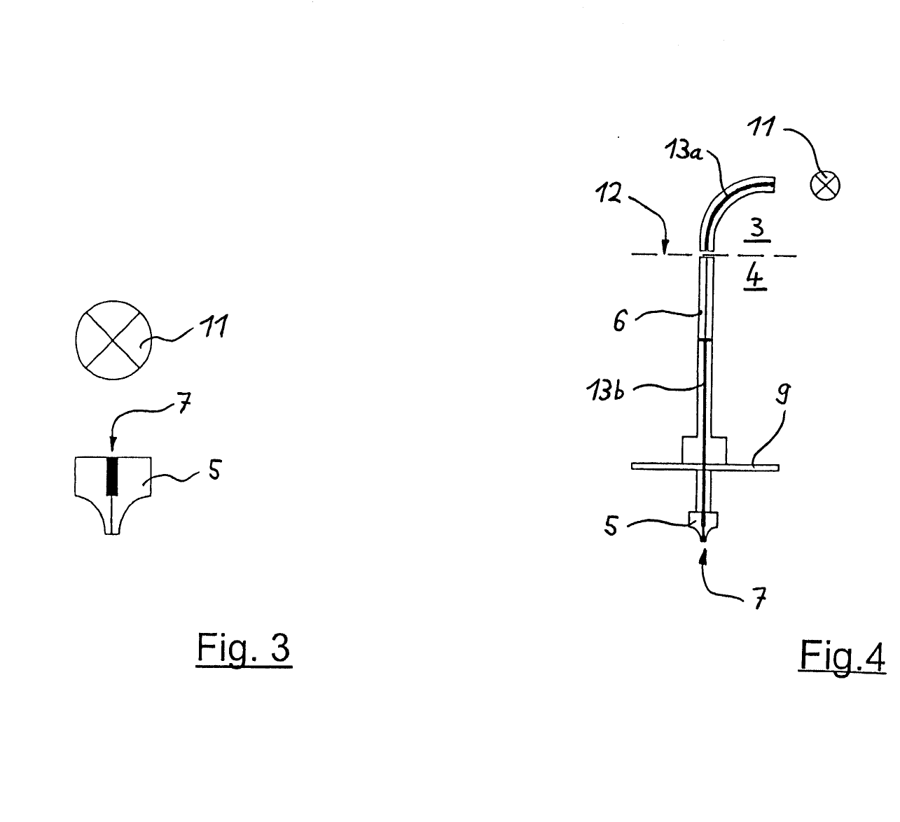

FIG. 3 shows a diagrammatic illustration of a suction pipette with internal illumination, and

FIG. 4 shows a diagrammatic illustration of a center sleeve with internal illumination and coupled light source.

In accordance with the exemplary embodiment according to FIG. 1, a component receptacle device 1 of an automatic placement machine for printed circuit boards 2 is designed in the manner of a 12-segment turret head with horizontal axis of rotation which can be moved on a portal axle system (not specifically shown) in the X- and Y-direction. The component receptacle device 1 comprises a stator 3, which is connected to the portal axle system, and a rotor 4, which is mounted rotatably on said stator. The rotor 4 has suction pipettes 5 which project in a star-shaped manner and are held in a manner that allows them to be exchanged by center sleeves 6, arranged rotationally symmetrically. The suction pipette 5 holds a component 8 by suction, by means of an air duct 7, running longitudinally on the inside, in order to transport said component. The components 8 collected by the suction pipettes 5 of the rotor 4 can be rotated by means of indexed rotation of the rotor 4 progressively into their respective end placement position above the printed circuit board 2. An incremental encoder arrangement is provided for the individual rotary positioning of each suction pipette 5 about its own axis.

In accordance with FIG. 2, the incremental encoder arrangement comprises a rotatable segmental disc 9, which is fitted coaxially to the center sleeve 6. The segmental disc 9 interacts with a read head (not specifically illustrated here) in order to perform the positioning of the suction pipette 5. The center sleeve 6 is part of the rotor 4 and serves for the fixing and longitudinal as well as rotary movement of the suction pipette 5. Arranged laterally beside the suction pipette 5 is an optical sensor means which is designed in the manner of a camera 10 and can be used to detect the ACTUAL position of the suction pipette 5 by way of the longitudinal profile parameters thereof. Evaluation means (not specifically illustrated) connected downstream of the camera 10 supply information about deviations with respect to a defined desired position of the suction pipette 5 as well as configuration information in order to enable, in particular, exact positioning of the suction pipette 5 when receiving components 8.

As emerges from FIG. 3, the suction pipette 5 is provided with a light source 11, so that the emerging light stands out optically along the air duct 7 running within the suction pipette 5. By virtue of this measure, the position and configuration of the suction pipette 5 can be determined very accurately by means of the camera (not illustrated here).

In the arrangement according to FIG. 4, the light source 11 for internal illumination is placed outside suction pipette 5 or center sleeve 6 on the stator 3 as stationary side of the component receptacle device. There is an optical coupling toward the light source 11 at the boundary point 12 to the rotor 4 as movable side. Optical fibers 13a and 13b are used for light-guiding purposes. For the connection of the center sleeve 6 to the light guidance, it has, in its rear region remote from the suction pipette 5, a hole which runs coaxially with respect to the longitudinally running air duct 7 and into which the optical fibers 13b are introduced in a sealed manner. The optical fibers 13a on the stator 3 are bent to match the local conditions.

The embodiment of the present invention is not restricted to the exemplary embodiments that are specified above only as preferences. Rather, modifications thereof are also conceivable which, despite a different configuration, engage within the scope of protection of the present invention. In particular, the invention is not restricted to the longitudinal profile parameters standing out through internal illumination of the suction pipette.

1. A component receptacle device (1) of an automatic placement machine for printed circuit boards (2), having at least one suction pipette (5) which serves for receiving a component (8) and interacts with an optical sensor means,
characterized
in that the optical sensor means is arranged laterally beside the suction pipette (5) in such a way that the actual position of the suction pipette (5) can be detected by way of the longitudinal profile parameters thereof, evaluation means connected downstream providing information about deviations with respect to a defined desired position of the suction pipette (5) as well as configuration information.

2. The component receptacle device as claimed in claim 1,
characterized
in that the optical sensor means is designed in the manner of a camera (10).

3. The component receptacle device as claimed in claim 1 or 2,
characterized
in that the suction pipette (5) and/or the adjoining center sleeve (6) is internally illuminated in order that, using the longitudinal profile parameters that can be derived therefrom, the actual position as well as the configuration of the suction pipette (5) are detected optically correctly.

4. The component receptacle device as claimed in claim 3,
characterized
in that the internal illumination is effected by light being scattered into the suction pipette (5) or center sleeve (6) at the end, the longitudinally running air duct (7) standing out as bright relative to the surrounding.

5. The component receptacle device as claimed in claim 3 or 4,
characterized
in that a light source (11) for internal illumination is arranged in the suction pipette (5) or in the center sleeve (6).

6. The component receptacle device as claimed in claim 3 or 4,
characterized
in that the light source (11) for internal illumination is arranged outside suction pipette (5) or center sleeve (6) and means are provided for forwarding the light from the light source (11) to the suction pipette (5) or center sleeve (6).

7. The component receptacle device as claimed in claim 6
characterized
in that the means for forwarding the light are designed as optical fibers (13).

8. The device as claimed in claim 7,
characterized
in that, for connection of the optical fibers (13), the center sleeve (6) has, in its rear region remote from the suction pipette (5), a hole which runs coaxially with respect to the longitudinally running air duct (7) and into which the optical fibers are introduced in a sealed manner.

9. The device as claimed in one of claims 6 to 8,
characterized
in that the light source (11) can be installed on the stationary side of the component receptacle device (1), there being an optical coupling to the light source (11) at the boundary point (12) toward the movable side.
